(19) United States
(12) Patent Application Publication
(10) Pub. No.: US 2005/0166245 A1
(43) Pub. Date: Jul. 28, 2005

(54) Method and device for transmitting scalable video bitstream

(75) Inventors: Sung-chol Shin, Suwon-si (KR); Bae-keun Lee, Bucheon-si (KR)

Correspondence Address: SUGHRUE MION, PLLC, 2100 PENNSYLVANIA AVENUE, N.W., SUITE 800, WASHINGTON, DC, 20037, US

(73) Assignee: SAMSUNG ELECTRONICS CO., LTD.

(21) Appl. No.: 11/041,746

(22) Filed: Jan. 25, 2005

(30) Foreign Application Priority Data
Jan. 28, 2004 (KR) 10-2004-0005481

(51) Int. Cl. H04N 7/173; H04N 7/10; H04N 7/025; H04N 7/16

(52) U.S. Cl. 725/104; 725/32; 725/86; 725/1

(57) ABSTRACT

Provided are a method and device for transmitting a scalable video stream suitable for a user's request by processing a scalable bitstream according to the user's request. The device includes a source of a scalable bitstream containing a video content requested by a user, a controller determining the quality of the video content based on the user request and user profile information, and a predecoder processing the scalable bitstream according to the determined quality for transmission.

### CROSS-REFERENCE TO RELATED APPLICATION

This application claims priority from Korean Patent Application No. 10-2004-0005481 filed on Jan. 28, 2004 in the Korean Intellectual Property Office, the disclosure of which is incorporated herein by reference in its entirety.

### BACKGROUND OF THE INVENTION

1. Field of the Invention

The present invention relates to a method and device for transmitting a scalable video stream, and more particularly, to a method and device for delivering video content suitable for a network and a user's environment by processing a scalable bitstream according to a user's request for transmission.

2. Description of the Related Art

With the development of information communication technology including the Internet, video communication as well as text and voice communication has explosively increased.

Multimedia data requires a large capacity of storage media and a wide bandwidth for transmission since the amount of multimedia data is usually large. Accordingly, a compression coding method is requisite for transmitting multimedia data including text, video, and audio.

A basic principle of data compression lies in removing data redundancy. Data can be compressed by removing spatial redundancy in which the same color or object is repeated in an image, temporal redundancy in which there is little change between adjacent frames in a moving image or the same sound is repeated in audio, or mental visual redundancy taking into account human eyesight and limited perception of high frequency.

Data compression can be classified into lossy/lossless compression according to whether source data is lost, intraframe/interframe compression according to whether individual frames are compressed independently, and symmetric/asymmetric compression according to whether time required for compression is the same as time required for recovery.

Data compression is defined as real-time compression when a compression/recovery time delay does not exceed 50 ms and as scalable compression when frames have different resolutions.

For text or medical data, lossless compression is usually used. For multimedia data, lossy compression is usually used.

Meanwhile, intraframe compression is usually used to remove spatial redundancy, and interframe compression is usually used to remove temporal redundancy.

Different types of transmission media for multimedia have different performance.

Currently used transmission media have various transmission rates. For example, an ultrahigh-speed communication network can transmit data of several tens of megabits per second while a mobile communication network has a transmission rate of 384 kilobits per second.

In conventional video coding methods such as Motion Picture Experts Group (MPEG)-1, MPEG-2, H.263, and H.264, temporal redundancy is removed by motion compensation based on motion estimation and compensation, and spatial redundancy is removed by transform coding.

These methods have satisfactory compression rates, but they do not have the flexibility of a truly scalable bitstream since they use a reflexive approach in a main algorithm.

Accordingly, to support transmission media having various speeds or to transmit multimedia at a data rate suitable to a transmission environment, data coding methods having scalability, such as wavelet video coding and subband video coding, may be suitable to a multimedia environment.

Scalability indicates the ability to partially decode a single compressed bitstream. Scalability includes spatial scalability indicating a video resolution, Signal to Noise Ratio (SNR) scalability indicating a video quality level, temporal scalability indicating a frame rate, and a combination thereof.

Scalable video coding involves compressing an original image and converting the same into a video signal with desired quality for transmission to a decoder. A decoder decompresses and plays back the received video signal.

In general, since a consumer wants to know whether content is what he/she needs before purchasing, it is necessary for the consumer to preview the details of the content. In this case, a content provider provides a low quality version of the content to a user for preview purposes and a high quality version of the content upon purchasing. When a single content needs to be transmitted or received at various resolutions, a scalable video coding method may be used.

However, a conventional scalable video coding method has the drawback of degrading transmission speed by always delivering a high quality content bitstream that represents various qualities of the original content regardless of a user's request.

Another drawback is that the conventional method needs a separate process of extracting content of desired quality from the received bitstream.

### SUMMARY OF THE INVENTION

The present invention provides content adapted to a user's various needs and a content provider's business purposes.

The present invention also provides a content of desired quality to a user at high transmission rate without any additional process by processing content according to quality determined by the user's request for transmission.

The above stated object as well as other objects, features and advantages, of the present invention will become clear to those skilled in the art upon review of the following description, the attached drawings and appended claims.

According to an aspect of the present invention, there is provided a device for transmitting a scalable video stream including a source of a scalable bitstream containing a video content requested by a user, a controller determining the quality of the video content based on the user request and user profile information, and a predecoder processing the scalable bitstream according to the determined quality for transmission.

According to another aspect of the present invention, there is provided a method for transmitting a scalable video stream comprising determining a scalable bitstream containing a video content requested by a user, and processing the scalable bitstream according to the determined quality for transmission.

The determining of the quality of bitstream may comprise performing user authentication, determining a user request for the selected video content, and determining the quality of the bitstream to be transmitted based on the user request and user profile information.

The user request may be a preview or purchase of the video content, and the user profile information may be information on payment of a fee for the video content.

### BRIEF DESCRIPTION OF THE DRAWINGS

The above and other features and advantages of the present invention will become more apparent by describing in detail exemplary embodiments thereof with reference to the attached drawings in which:

FIG. 1 is a schematic block diagram of an encoder according to an embodiment of the present invention;

FIG. 2 is a schematic block diagram of a decoder according to an embodiment of the present invention;

FIG. 3 is a block diagram of a device for transmitting a scalable video stream according to an embodiment of the present invention;

FIG. 4 is a flowchart illustrating a method for transmitting a scalable video stream;

FIG. 5 schematically illustrates a temporal decomposition process in scalable video encoding and decoding based on Motion Compensated Temporal Filtering (MCTF) according to an embodiment of the present invention;

FIG. 6 schematically illustrates a process of decomposing an input image or frame into subbands by wavelet transform according to an embodiment of the present invention; and

FIG. 7 is a flowchart illustrating a method for transmitting a scalable video stream according to another embodiment of the present invention.

### DETAILED DESCRIPTION OF THE EXEMPLARY EMBODIMENTS OF THE INVENTION

Advantages and features of the present invention and methods of accomplishing the same may be understood more readily by reference to the following detailed description of exemplary embodiments and the accompanying drawings. The present invention may, however, be embodied in many different forms and should not be construed as being limited to the embodiments set forth herein. Rather, these embodiments are provided so that this disclosure will be thorough and complete and will fully convey the concept of the invention to those skilled in the art, and the present invention will only be defined by the appended claims. Like reference numerals refer to like elements throughout the specification.

The configuration and operation of a device for transmitting a scalable video stream according to an embodiment of the present invention will now be described. To aid in the understanding of the present invention, a scalable video encoder performing video coding supporting scalability, a decoder decoding the video bitstream received from the encoder, and a device for transmitting a scalable video stream by processing the video bitstream received from the encoder for transmission to the decoder will be described sequentially below.

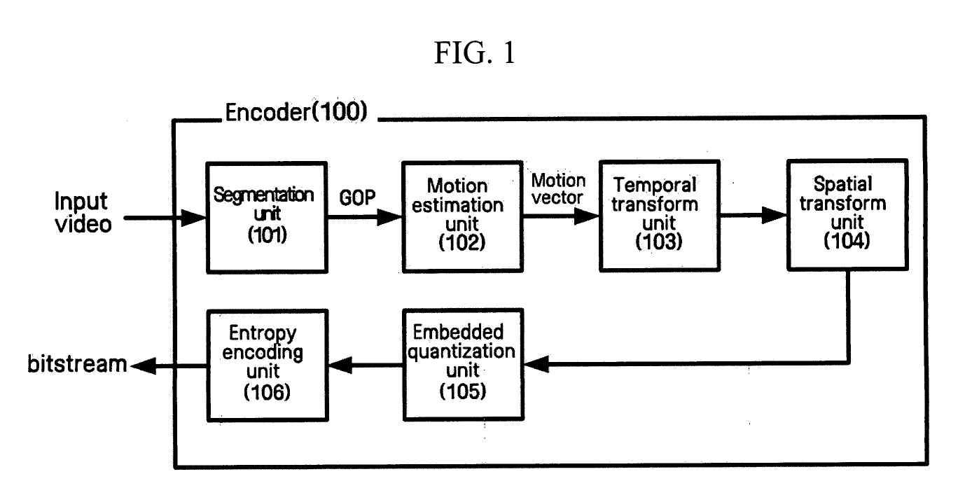

FIG. 1 is a schematic block diagram of an encoder according to an embodiment of the present invention.

Referring to FIG. 1, an encoder 100 according to an embodiment of the present invention includes a segmentation unit 101, a motion estimation unit 102, a temporal transform unit 103, a spatial transform unit 104, an embedded quantization unit 105, and an entropy encoding unit 106.

The segmentation unit 101 divides an input video into basic encoding units, i.e., groups of pictures (GOPs).

The motion estimation unit 102 performs motion estimation with respect to frames included in each GOP, thereby obtaining a motion vector. A hierarchical method such as a Hierarchical Variable Size Block Matching (HVSBM) may be used to implement the motion estimation.

The temporal transform unit 103 decomposes frames into low-and high-frequency frames in a temporal direction using the motion vector obtained by the motion estimation unit 102, thereby reducing temporal redundancy.

For example, an average of frames may be defined as a low-frequency component, and half of a difference between two frames may be defined as a high-frequency component. Frames are decomposed in units of GOPs.

Frames may be decomposed into high- and low-frequency frames by comparing pixels at the same positions in two frames without using a motion vector. However, the method not using a motion vector is less effective in reducing temporal redundancy than the method using a motion vector.

In other words, when a portion of a first frame is moved in a second frame, an amount of a motion can be represented by a motion vector. The portion of the first frame is compared with a portion to which a portion of the second frame at the same position as the portion of the first frame is moved by the motion vector, that is, a temporal motion is compensated. Thereafter, the first and second frames are decomposed into low- and high-frequency frames.

Motion Compensated Temporal Filtering (MCTF) may be used for temporal filtering.

The spatial transform unit 104 removes spatial redundancies from the frames from which the temporal redundancies have been removed, and creates transform coefficients. For spatial transformation, the present invention uses a wavelet transform. Here, the wavelet transform is used to decompose a frame into low and high frequency subbands and determine transform coefficients, i.e., wavelet coefficients for the respective subbands.

More specifically, the frame is decomposed into four portions. A quarter-sized image (L image) that is similar to the entire image appears in the upper left portion of the frame and information (H image) needed to reconstruct the entire image from the L image appears in the other three portions. In the same way, the L image may be decomposed into a quarter-sized LL image and information needed to reconstruct the L image.

Image compression using the wavelet transform is applied to JPEG 2000 standard, and removes spatial redundancies between frames. Furthermore, the wavelet transform enables the original image information to be stored in the transformed image that is a reduced version of the original image, in contrast to a Discrete Cosine Transform (DCT) method, thereby allowing video coding that provides spatial scalability using the reduced image.

In the present invention, however, the wavelet transform is provided for illustration only. In a case where spatial scalability is not necessarily intended to be achieved, the DCT method, which has been conventionally widely used in moving image compression like in MEPG-2, may be employed.

The embedded quantization unit 105 performs embedded quantization on the wavelet coefficients obtained by the spatial transform unit 104 for each wavelet block and rearranges the quantized coefficients according to significance. Embedded Zerotrees Wavelet Algorithm (EZW), Set Partitioning in Hierarchical Trees (SPIHT), and Embedded ZeroBlock Coding (EZBC) may be used as algorithms performing embedded quantization on the wavelet coefficients for each wavelet block in this way.

These algorithms make good use of a spatial relation between pixels in a wavelet domain used in the present invention, and so are suitable for use in the embedded quantization process according to the present invention.

Spatial relationships between pixels are expressed in a tree shape. Effective coding can be carried out using the fact that when a root in the tree is 0, children in the tree have a high probability of being 0. While pixels having relevancy to a pixel in the L band are being scanned, algorithms are performed.

The entropy encoding unit 106 converts the wavelet coefficient quantized by the embedded quantization unit 105 and information regarding motion vector and header information generated by the motion estimation unit 102 into a compressed bitstream suitable for transmission or storage. The entropy encoding may be performed using predictive coding, variable-length coding (e.g., Huffman coding), arithmetic coding, etc.

The present invention can be applied to moving video as well as still video (image). Similarly with the moving video, an input still image may be converted into a bitstream after passing through the spatial transform unit 104, the embedded quantization unit 105, and the entropy encoding unit 106.

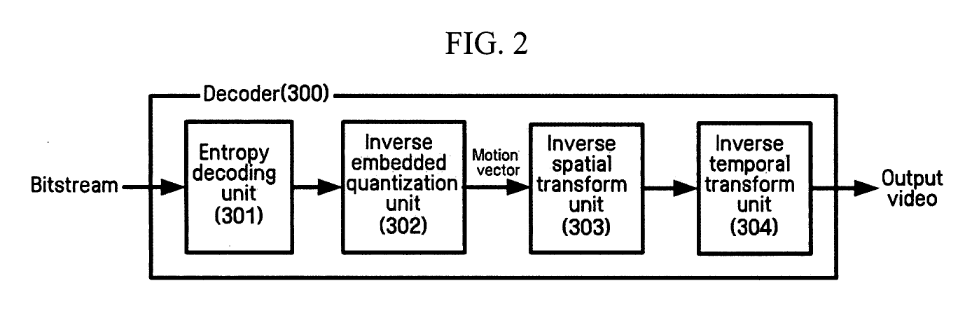

FIG. 2 is a schematic block diagram of a decoder according to an embodiment of the present invention.

The decoder 300 includes an entropy decoding unit 301, an inverse embedded quantization unit 302, an inverse spatial transform unit 303, and an inverse temporal transform unit 304.

The decoder 300 operates in a substantially reverse direction to the encoder 100. However, while motion estimation has been performed by the motion estimation unit 102 of the encoder 100 to determine a motion vector, an inverse motion estimation process is not performed by the decoder 300, since the decoder 300 simply receives the motion estimation unit 102 for use.

Like in the encoder 100, the operation of the decoder 300 according to an embodiment of the present invention can be applied to moving video as well as still images. Similarly with the moving video, the bitstream received from the encoder 100 may be converted back into an output image after passing through the entropy decoding unit 301, the inverse embedded quantization unit 302, the inverse spatial transform unit 303, and the inverse temporal transform unit 304.

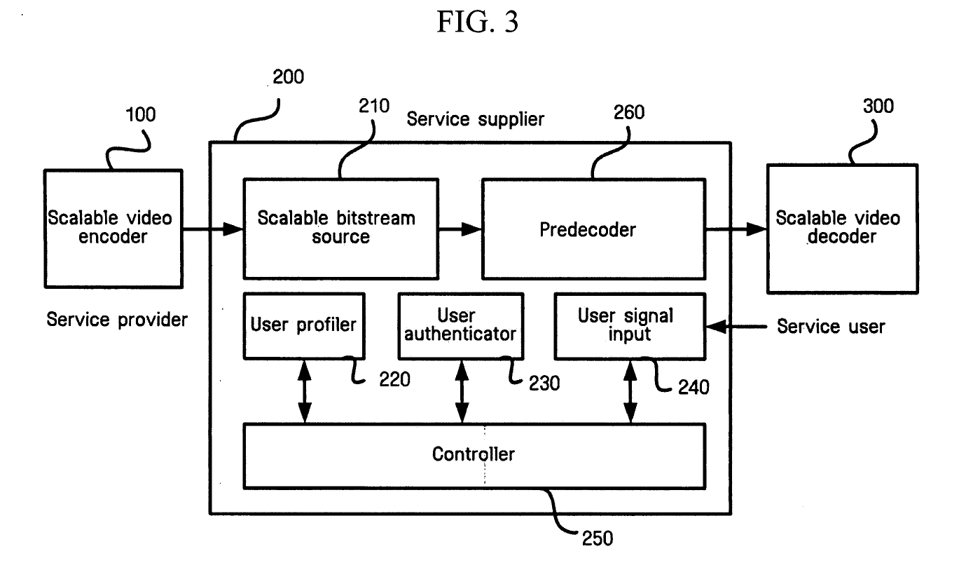

FIG. 3 shows a device 200 for transmitting a scalable video stream according to an embodiment of the present invention. The device 200 includes a scalable bitstream source 210, a user profiler 220, a user authenticator 230, a user signal input 240, and a controller 250.

The scalable bitstream source 210 receives a scalable bitstream encoded to have temporal, spatial, and signal-to-noise ratio (SNR) scalabilities from a scalable video encoder 100. The bitstream is produced by compressing an original image at high quality and can be divided into signals with various qualities.

The scalable bitstream may also be transmitted by an external video content supplier after encoding in the scalable video encoder 100.

The user profiler 220 contains user profile information such as details on video content use and payment.

The use authenticator 230 determines whether a user is entitled to use services associated with desired video content, i.e., by checking whether payment for an appropriate bitstream quality has been made.

The user signal input 240 receives a signal representing the desired quality of a video content. A low quality signal is transmitted only for preview purposes while a high quality signal is transmitted upon purchasing the content. The quality is determined by information on frame rate, resolution, image quality of the encoded bitstream.

The controller 250 determines the user's authenticity according to the information received from the user authenticator 230 as well as the quality of a bitstream for the desired video content based on the information received from the user signal input 240.

The predecoder 260 is controlled by the controller 250 and extracts and processes a scalable bitstream containing information on the required frame rate, resolution, and image quality for transmission to the user.

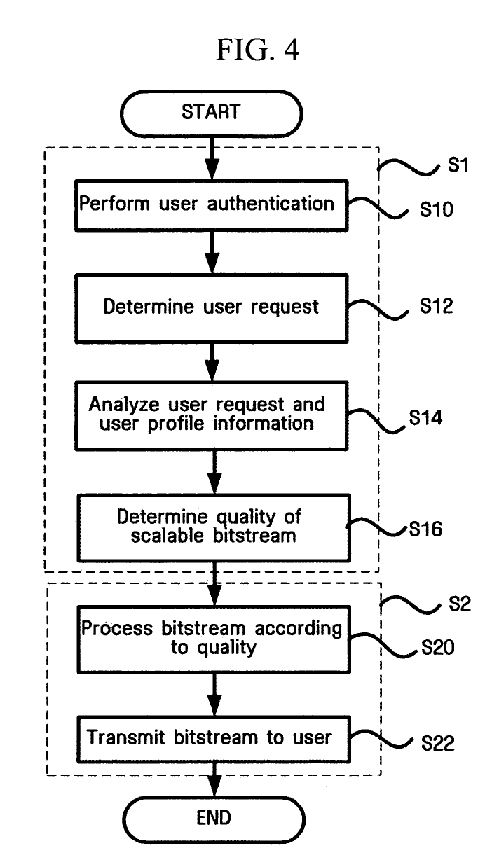

FIG. 4 is a flowchart illustrating a method for transmitting a scalable video stream according to an embodiment of the present invention.

Referring to FIGS. 3 and 4, the method mainly includes determining the quality of a scalable bitstream containing a video content requested by a user (step S1) and processing the scalable bitstream according to the determined quality for transmission (step S2).

The step S1 of determining the quality of the bitstream includes performing user authentication (step S10), determining a user request (step S12), analyzing the user request and user profile information (step S14), and determining the quality of a bitstream to be transmitted (step S16).

In step S10, it is determined whether the user is entitled to be provided with the video content based on the user authentication information recorded in the user authenticator 230.

To implement user authentication, each user may be assigned a unique user ID or password that must be entered each time he/she is provided with a video content. For paid user authentication, a user ID or password is allocated to a prepaid user only. Alternatively, each user may first be assigned a user ID or password and then pay a fee for a desired video content selected from a menu. In this case, payment of the fee is recorded in the user profiler 220.

To determine the user request in step S12, the user signal input 240 analyzes the received user request containing requirements for quality of desired video or video content such as resolution, image quality, and frame rate. Here, the frame rate determines the speed at which the received video stream is played back, the resolution determines the sharpness and clarity of an image, and the image quality determines the quality of an image such as hue and brightness.

For example, to watch a preview of a movie before selecting the movie from a menu, a user may request a video content with low resolution and low image quality to reduce the amount of a bitstream to be transmitted since the preview simply needs to provide information required for selection of a movie. The video content may also have a high frame rate required for high-speed playback to quickly search the menu for the desired movie. In this case, information on the resolution, image quality, and frame rate requested by the user is sent to the user signal input 240 for use in processing a bitstream having scalability.

Meanwhile, the user request may be information on one quality of the video content like in the illustrative embodiment or information on a plurality of qualities of the video content. When the user requests a video content with a plurality of qualities, it is desirable to begin transmission of the video content when the capacity of a network and user environment exceeds a predetermined level since a high quality video content has a large size.

The result obtained after analyzing the user request and the user profile information in step S14 is used for the controller 250 to determine the quality of the video content.

For example, for a user who frequently uses a movie content for which has been paid, the user profile information may contain details on use of movie content and payment as well as weight information containing incentives offered to the user for content use and payment. The incentives may include one level upgrade of image quality for use of paid movie content 10 times or accumulation of 10% of the total payment.

In step S16, the quality of the scalable bitstream to be transmitted is determined by the controller 250 based on the user request signal received from the user signal input 240 and the user profile information received from the user profiler 220.

That is, a low quality signal is transmitted upon request of a preview version of the content of an arbitrary movie from a user while a high quality signal is transmitted only when determined to be appropriate to transmit the high quality signal based on the result of searching the information recorded in the user profiler 220 upon request of a high quality content. The amount of bitstream to be transmitted is adjusted by the predecoder 260 according to the determined quality.

The step S2 of processing the scalable bitstream according to the determined quality for transmission is divided into two sub-steps: processing the scalable bitstream according to the determined quality (step S20) and transmitting an extracted bitstream to the user (step S22).

In step S20, the scalable bitstream is processed according to the determined quality by truncating an unnecessary part of the bitstream. The scalable bitstream refers to a video signal having scalability and which is encoded by the scalable video encoder 100. The video content coding in the scalable video encoder 100 may be performed by a video content provider or external provider. In the latter case, video content coding and bitstream processing may be performed by separate devices.

A method of processing a scalable bitstream will now be described.

To determine the quality of the bitstream such as frame rate, resolution, and image quality, the scalable bitstream encoded by the scalable video encoder 100 to have temporal, spatial, and SNR scalabilities may be performed by extracting or removing a predetermined portion of the bitstream. Therefore, a method for processing a scalable bitstream will now be described in relation to a coding process performed by the scalable video encoder 100 of FIG. 1.

A process of processing a bitstream coded to have temporal scalability by MCTF method and adjusting a frame rate will now be described.

First, scalable video coding and decoding based on Motion Compensated Temporal Filtering (MCTF) will be described.

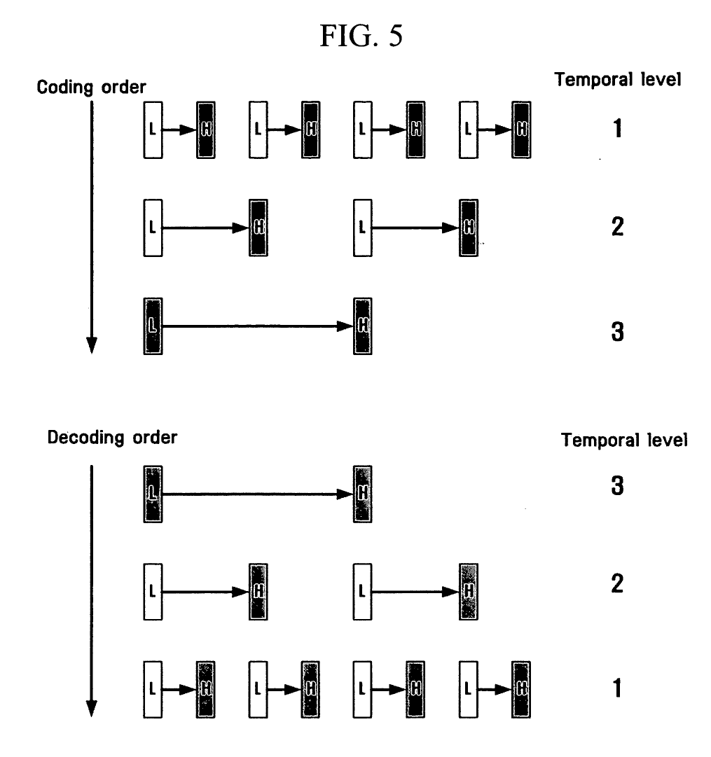

As shown in FIG. 5, in a coding process, pairs of frames at a low temporal level are temporally filtered and then decomposed into pairs of L frames and H frames at a higher temporal level, and the pairs of L frames are again temporally filtered and decomposed into frames at a higher temporal level. An encoder performs wavelet transformation on one L frame at the highest temporal level and the H frames and generates a bitstream. Here, an L frame is a low frequency frame corresponding to an average of frames while an H frame is a high frequency frame corresponding to a difference between frames.

In other words, the encoder 100 encodes frames from a low temporal level to a high temporal level, while a decoder performs an inverse operation to the encoder 100 on the frames indicated by shading and obtained by inverse wavelet transformation from a high level to a low level for reconstructions.

L and H frames at temporal level 3 are used to reconstruct two L frames at temporal level 2, and the two L frames and two H frames at temporal level 2 are used to reconstruct four L frames at temporal level 1. Finally, the four L frames and four H frames at temporal level 1 are used to reconstruct eight frames.

A method of adjusting a frame rate by processing a scalable video stream coded based on the MCTF method will now be described.

For example, when temporal scalability needs to be adjusted for transmission of a low quality version of content upon selecting a preview, only some frames in a group of pictures (GOP) may be cut for transmission. That is, when only a bitstream corresponding to two of eight frames known as a GOP is transmitted, a low quality video is played back since the bitstream is decoded at a low frame rate.

While the present invention has been particularly shown and described with reference to the illustrative embodiment using the MCTF-based video coding scheme, it will be understood by those of ordinary skill in the art that various changes in form and details may be made therein. That is, the present invention may implement various modules designed to change a frame rate by decoding a portion of a scalable video stream coded according to MCTF, UMCTF, or other video coding schemes offering temporal scalability, which is possible by adjusting a temporal level according to a frame rate suitable for a set screen size.

Here, other video coding schemes offering temporal scalability may use Successive Temporal Approximation and Referencing (STAR) that performs temporal transformation at limited temporal levels to control delay time while maintaining temporal scalability as much as possible.

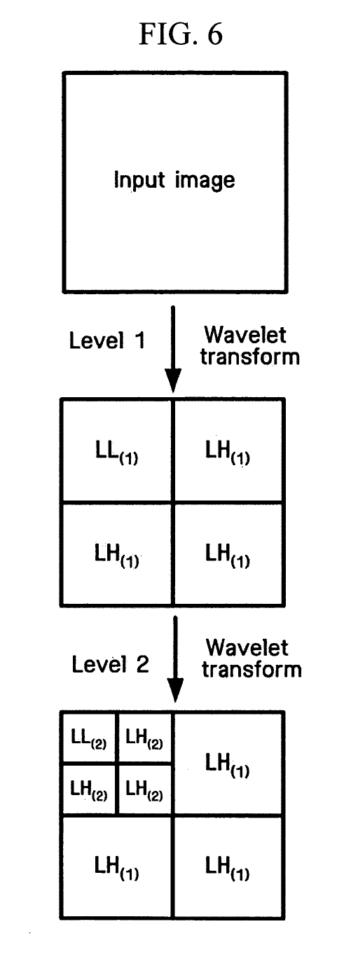

Next, a method for adjusting resolution by processing a bitstream encoded with a wavelet transform to have spatial scalability will now be described in relation to FIG. 6.

FIG. 6 illustrates a process of decomposing an input image or frame into subbands by two-level wavelet transform in the spatial transform unit 104 according to an embodiment of the present invention.

Referring to FIG. 6, the frame is decomposed into one low frequency subband termed Low-Low (LL) (1) in the upper left quadrant of the frame and three high frequency subbands termed Low-High (LH) (1). The subband LL(1) is further decomposed by a second-level wavelet transform into three high frequency subbands LH(2) and one low frequency subband LL(2).

The method for adjusting resolution may be realized by removing information other than necessary subbands from the bitstream encoded with the wavelet transform.

For example, a video stream needs to be transmitted at resolution that is a quarter of resolution of a screen offered by a video provider after selecting a preview function, the predecoder 260 is controlled by the controller 240 to remove information other than the subband LL(1) from the bitstream for transmission to the user. Furthermore, when the user requests a video stream having resolution that is one-sixteenth screen resolution in order to use a Picture In Picture (PIP) function, information other than the subband LL(2) may be removed from the bitstream before transmission.

A method of processing a scalable bitstream in order to adjust a quality level of a bitstream coded to have a Signal to Noise (SNR) will now be described.

The SNR scalability performs embedded quantization by encoding only pixels having a value greater than a predetermined threshold, decreasing the threshold after encoding, and repeating the above process. The level of quality can be determined by the threshold.

Thus, for a user to generate a bitstream of predetermined quality using a bitstream coded to have SNR scalability, it is necessary to extract a bitstream containing information on pixels with values greater than a given threshold.

For example, when a user requests a video content with low resolution, a video content provider assigns a threshold required for low quality video according to the user's request and then removes an unnecessary bitstream containing information on pixels with a value greater than the threshold. That is, only a bitstream containing information on pixels with values greater than the assigned threshold is extracted to provide the same to the user.

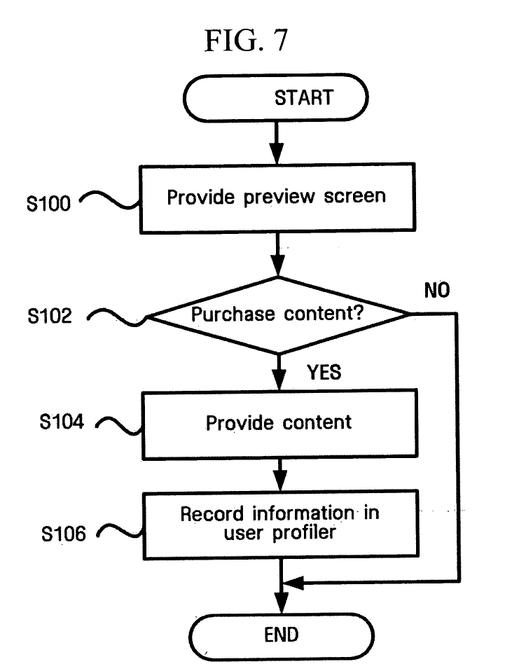

FIG. 7 is a flowchart illustrating a method for transmitting a scalable video stream using a video on demand (VOD) scheme according to another embodiment of the present invention.

The VOD scheme is implemented by providing a low quality version of video content to a user before a request is made and a high quality version of content after payment.

Referring to FIGS. 3 and 7, first, a user is provided with a preview screen of a video content in step S100. The preview screen may be provided upon a user's request or upon recommendation by a video content provider.

Then, after viewing the preview screen of video content, the user determines whether to purchase the content in step S102.

The content may contain the entire bitstream encoded by the encoder (100 of FIG. 1) or have better video quality than the preview version. The content may also have various qualities depending on the cost of purchasing it.

Upon purchasing the content after payment, the video content provider transmits the video content to the user in step S104. While performing this process, information on the selected video content and paid fee are recorded in the user profiler 220. The user profile information is used for the video content provider to recommend the video content. The information may also be used as a material for offering incentives such as image quality upgrade or cost discount.

In concluding the detailed description, those skilled in the art will appreciate that many variations and modifications can be made to the exemplary embodiments without substantially departing from the principles of the present invention. Therefore, the disclosed exemplary embodiments of the invention are used in a generic and descriptive sense only and not for purposes of limitation.

The method and device for transmitting a scalable video stream according to the present invention are able to provide content adapted to user's various needs and content provider's business purposes. The present invention can also provide a desired quality of content at high transmission speed without the need for an additional process by processing the content according to a quality determined by user's request.

1. A method for transmitting a scalable video stream comprising:
determining quality of a scalable bitstream containing a video content requested by a user; and
processing the scalable bitstream according to the determined quality for transmission.

2. The method of claim 1, wherein the quality of the scalable bitstream is determined by resolution, image quality, or frame rate.

3. The method of claim 1, wherein the determining of the quality of the bitstream comprises:
performing user authentication;
determining a user request for the video content; and
determining the quality of the bitstream to be transmitted based on the user request and user profile information.

4. The method of claim 3, wherein the user request is a preview or purchase of the video content.

5. The method of claim 3, wherein the user profile information is information on payment of a fee for the video content.

6. A device for transmitting a scalable video stream comprising:
a source of a scalable bitstream containing a video content requested by a user;
a controller determining the quality of the video content based on the user request and user profile information; and
a predecoder processing the scalable bitstream according to the determined quality for transmission.

7. The device of claim 6, wherein the quality of the bitstream is determined by resolution, image quality, or frame rate.

8. The device of claim 6, wherein the controller comprises:
a user authenticator performing user authentication;
a user signal input receiving a user's request for a video content; and
a user profiler containing information on the user.

9. The device of claim 6, wherein the user profiler contains information on payment of a fee for the video content.
